(19) United States
(12) Patent Application Publication
(10) Pub. No.: US 2005/0171788 A1
(43) Pub. Date: Aug. 4, 2005

(54) Wireless display system

(76) Inventors: Arshad A. Shah, Vancouver (CA); David Robert Wilkas, Richmond Hill (CA); Guoqiang Dai, Vancouver (CA); Yingjie Chen, Burnaby (CA); Jawad Shah, Goodwood (CA)

Correspondence Address: Clifford W. Vermette;Vermette & Co., Box 40, Granville Square, 200 Granville Street , Suite 230, Vancouver, V6C 1S4, CA

(21) Appl. No.: 10/766,821

(22) Filed: Jan. 30, 2004

(51) Int. Cl. G06F 17/60

(52) U.S. Cl. 705/1

(57) ABSTRACT

A wireless billboard system which includes a wireless billboard operative to receive and display text and graphics and to transmit messages wirelessly. A plurality of transmitter/receiver sites are located so as to receive wireless signals transmitted from a transmission site and to transmit them to the wireless billboard and to receive wireless transmissions from each of the wireless billboards and to transmit them to a user. A billboard management site is couplable to each of the transmitter/receiver sites and operative to receive transmissions from the plurality of transmitter/receiver sites and to transmit wirelessly to the transmitter/receiver sites.

### FIELD

The present invention relates to an electronic billboard system featuring an electronic display panel addressable either by a remote mobile device or through the internet by a billboard management system, the displays capable of displaying SMS messages as well as speech and graphic information;

### BACKGROUND

The advent of wireless protocols now makes it possible to communicate wirelessly without major security concerns and at speeds approaching landline communications. Presently, advertising at a number of different sites throughout the world requires separate implementation at each site. Thus, separate communication is required with each site providing instructions on what to display. There is delay added at each advertising site for communication and set up. A more efficient system of advertising on multiple sites is needed.

### SUMMARY OF THE INVENTION

According to the invention there is provided a wireless billboard system which includes a wireless billboard operative to receive and display text and graphics and to transmit messages wirelessly. A plurality of transmitter/receiver sites are located so as to receive wireless signals transmitted from a transmission site and to transmit them to the wireless billboard and to receive wireless transmissions from each of the wireless billboards and to transmit them to a user. A billboard management site is couplable to each of the transmitter/receiver sites and operative to receive transmissions from the plurality of transmitter/receiver sites and to transmit wirelessly to the transmitter/receiver sites.

The transmitter/receiver sites can be replaced by a carrier network which receives wireless transmissions, transports them to locations within its network and then transmits them to one of a user, the billboards and a management computer.

Preferably, there are a plurality of wireless billboards and each has its own identity.

The transmission site may be a gateway coupled to a server which can be either a web server or a content server. If a web server, the web server transmits and receives information over the Internet to computer. The latter computer may be a billboard management computer or a laptop computer or a commercial content provider.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic of a wireless billboard advertising system;

FIG. 2 is a schematic of the text message display system;

FIG. 3 is a flow chart for processing SMS messages;

FIG. 4 is a schematic diagram of a wireless billboard embedded controller;

FIG. 5 is a system diagram in which the Internet is not used;

FIG. 6 is a flow chart showing a sample SMS Interaction game; and

FIG. 7 is a flow chart showing the wireless billboard management functions.

### DETAILED DESCRIPTION WITH REFERENCE TO THE DRAWINGS

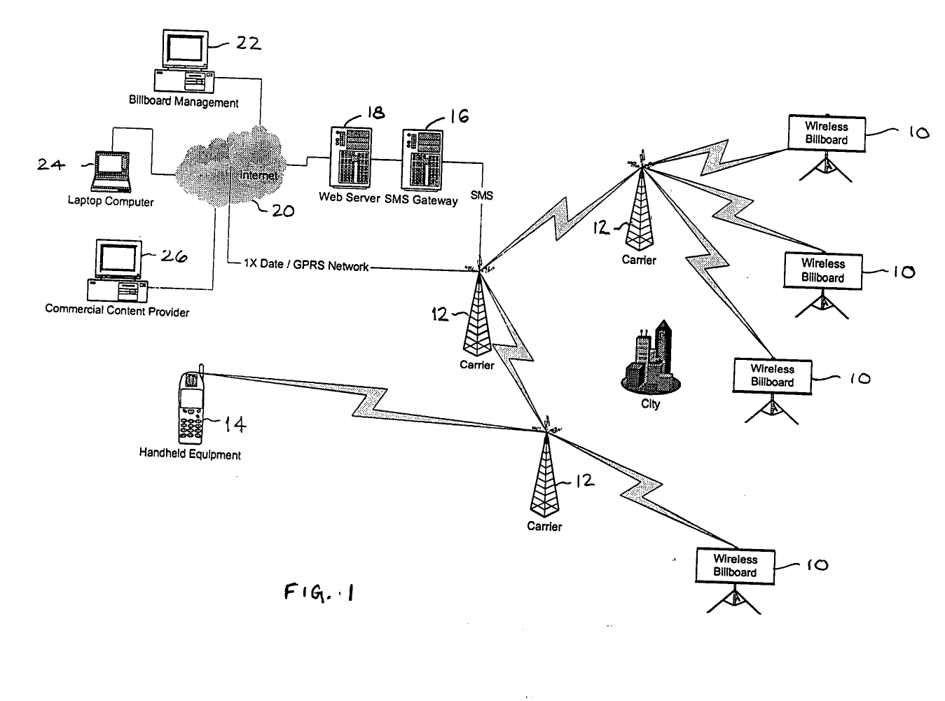

Referring to FIG. 1 the wireless billboard system consists of a number of wireless billboards 10 accessed by wireless communication with a closest one of each of a plurality of carriers 12. Communication with each carrier can be either with wireless handheld equipment such as cell or mobile phones 14, by wireless communication with a web server 18 and through the Internet or with a GPRS network to the Internet 20. From the Internet the communications can go to a billboard management computer 22, a laptop computer 24, or a commercial content provider 26. The wireless billboards 10 can be fixed or mounted on mobile vehicles such as automobiles, trucks, trains, subway vehicles, buses, etc. In the latter case the location of each billboard must be determined, such as by a Global Positioning System (GPS tracking) to enable communication with the carrier 12.

Message and control commands can be sent from the Billboard management computer 22, from the laptop computer 24, from a commercial content provider 26 through the Internet 20 to the web server 18. The web server 18 communicates with a gateway 16, which acts as a router between the web server 18 and the wireless circuit consisting of the carriers 12 and the wireless billboards 10. The gateway 16 authenticates users for authorized access, maintains a recorded account of who is on the network and the time, and acts as a server handing out IP addresses to users.

Messages in the form of SMS (i.e., short message service) commands or, containing the IP addresses of the destination billboards, travel through the Internet 20, through the web server 18 and gateway 16 to a carrier 12. The carriers 12 transmit the message to the wireless billboards 10 which execute the SMS command. Messages can also be sent from a cell phone 14 or from handheld equipment such as PDA's directly to the carrier 12 and then to the wireless billboards 10.

The carriers 12 could be antennas and the wireless billboards could all be located in a building or even a set of buildings and access to the billboards could be from mobile devices or by any other convenient means. Thus, the system of billboards could be local, city-wide, country-wide or globally dispersed.

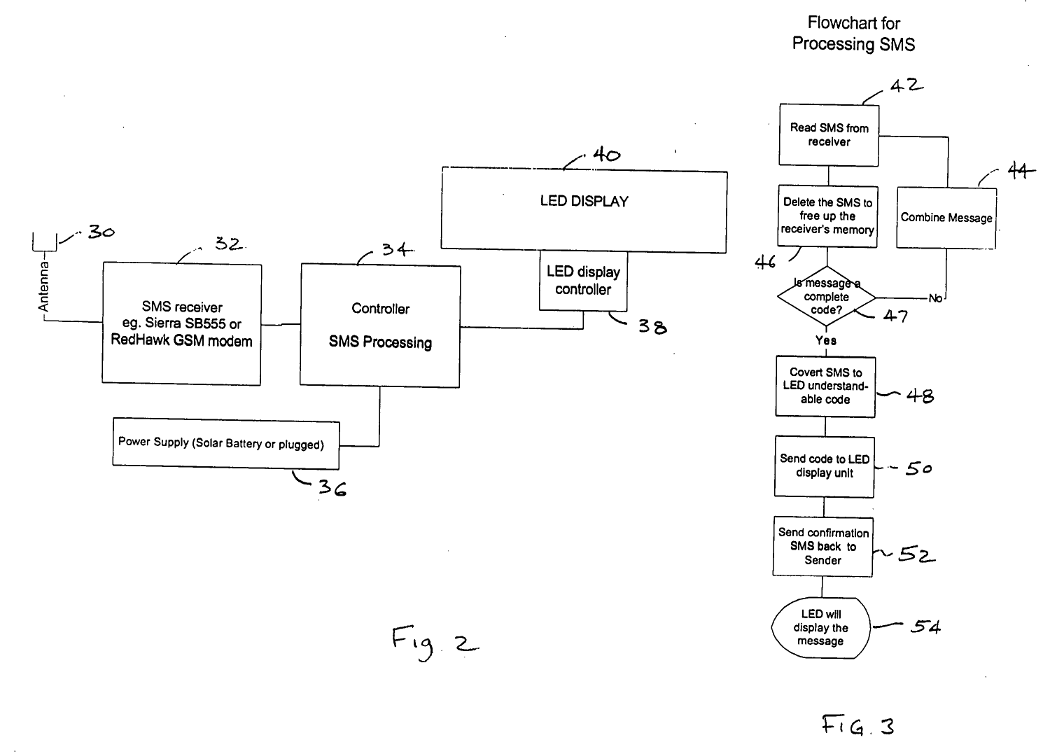

Referring to FIG. 2, the structure of a text message display system consists of an antenna 30, which receives the wireless signal and transmits it to an SMS receiver 32. The controller 34 combines all related messages to formulate the complete SMS message and deletes the SMS message in the receiver in order to free up the latter to receive the next message. The combined SMS message is then forwarded to the LED display controller 38, which converts the message to LED understandable code. The LED code is then transmitted to the LED display, which displays the message.

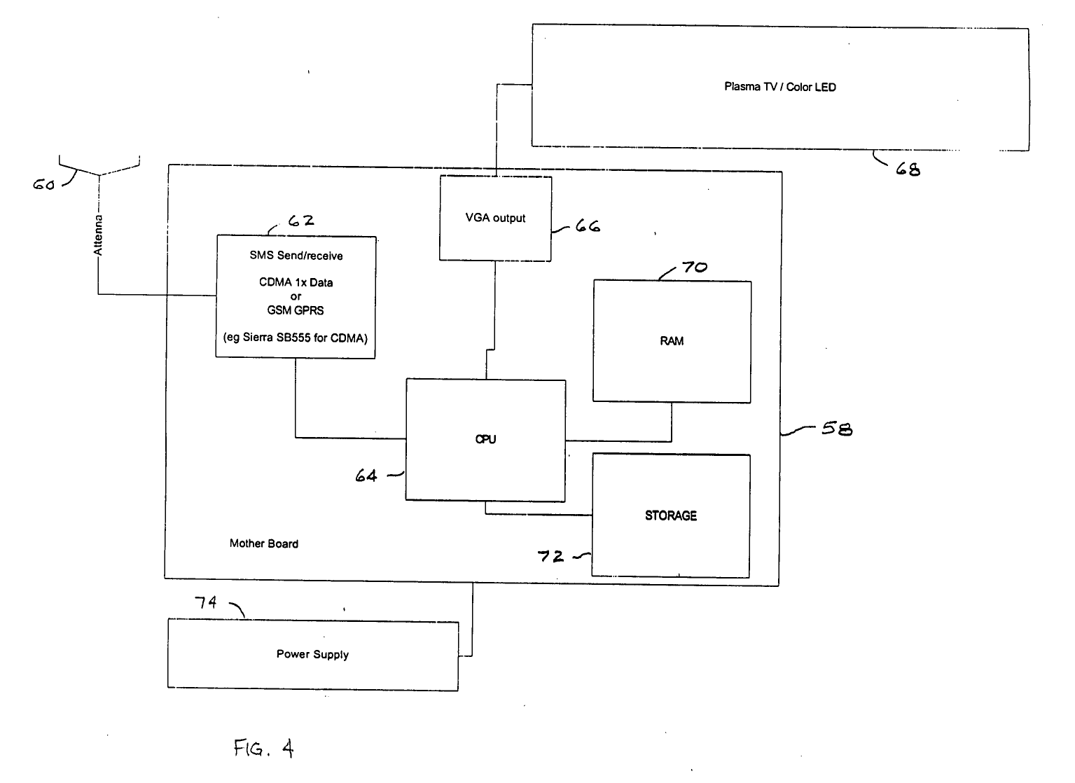

Referring to FIG. 3, a flow chart outlining the steps for processing SMS messages consists of step 42 in which the SMS message is read from the receiver 32 and after being read it is deleted from the receiver's memory to make room for the next message or portion of a message. The completeness of the SMS message is tested at step 47. If the message is incomplete it is combined at step 44 with the following message at step 42 and then passes through step 46 to step 47 once again. If the message is complete the SMS message is converted to LED understandable code at step 48. At step 50 this code is sent to the LED display 40 which then sends a confirmation SMS message back to the sender at step 52. The LED display 40 then displays the message.

Referring to FIG. 4, which shows a schematic drawing of a wireless billboard embedded controller, an antenna 60 is coupled to an SMS transceiver 62, which processes in CDMA, GSM and GPRS protocol. The signals from the transceiver 62 are sent to a CPU 64, which is supported by RAM memory 70 and storage memory 72. The CPU is coupled to a video graphics adapter (VGA) output 66. The entire structure other than the antenna is mounted on a motherboard 58. A power supply 74 is coupled to the motherboard 58 and provides power to each of the components mounted thereon.

SMS messages received by the transceiver 62 are processed by the CPU to covert them to signals compatible with the plasma or LED display 68. The VGA output circuit 66 receives output from the CPU 64 and provides the outputs for the colour and graphics to be displayed on the Plasma TV or colour LED display 68.

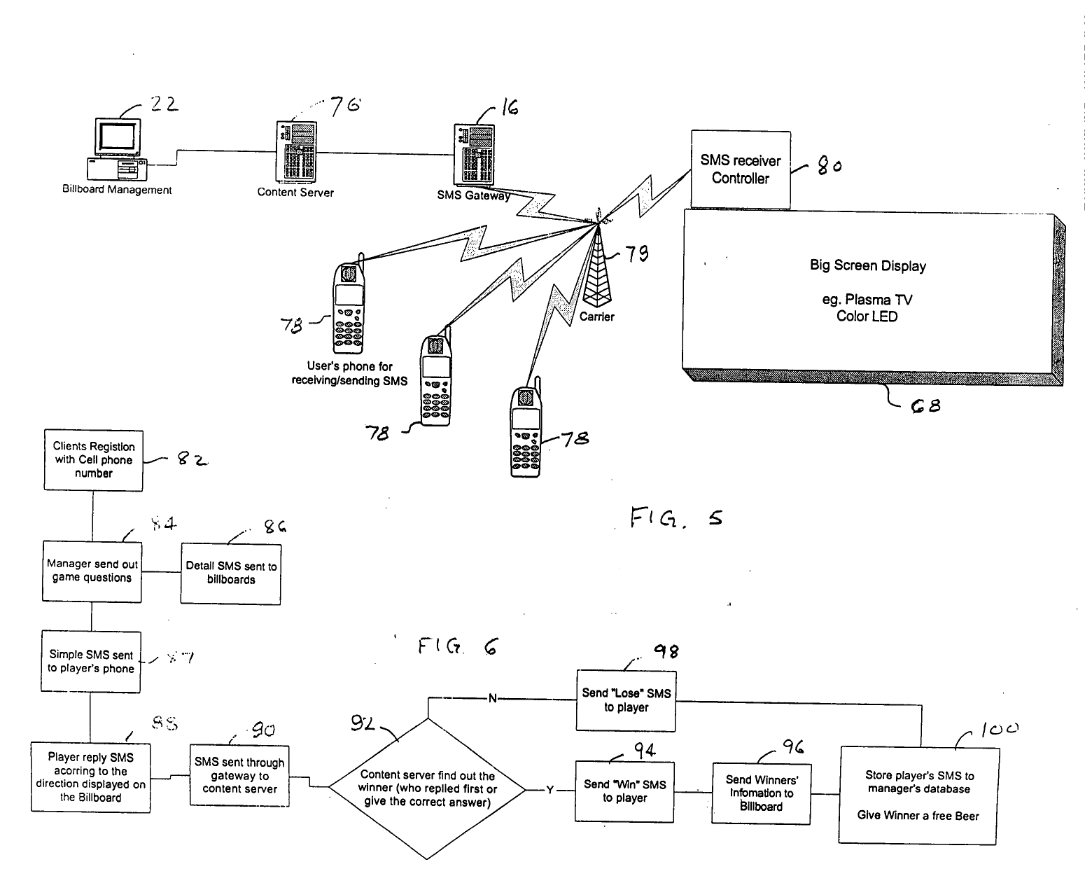

Referring to FIG. 5 a plurality of users with cellphones 78 communicate with a carrier tower 79 wirelessly. The carrier 79 is in wireless communication with both an SMS Gateway 16 and an SMS receiver controller 80. The SMS gateway 16 is coupled to a content server 76, which, in turn, is coupled to the billboard management computer 22. The SMS receiver controller 80 couples to the big screen display 68.

The operation of the network of FIG. 5 as applied to an interactive game is shown by the flow diagram of FIG. 6. First, at step 82 the clients 78 register with billboard management 22 with their cellphone numbers. Then at step 84 the manager sends out the game question with a detailed SMS being sent at step 86 to the billboards 68 and a simple SMS being sent at step 87 to the player's phone. At step 88 the player replies to the SMS message according to the direction displayed on the billboard 68. At step 90 the SMS message is sent through the gateway 16 to the content server 76. The content server 76 finds out the winner and then sends a “win” SMS to the player at step 94. Next, at step 96 the “winners” information is sent to the billboard 68. Next at step 100, the player's SMS is stored in the manager's database. At step 92 should the player being investigated be a loser, then at step 98 a “lose” message is sent to be stored in the manager's database at step 100.

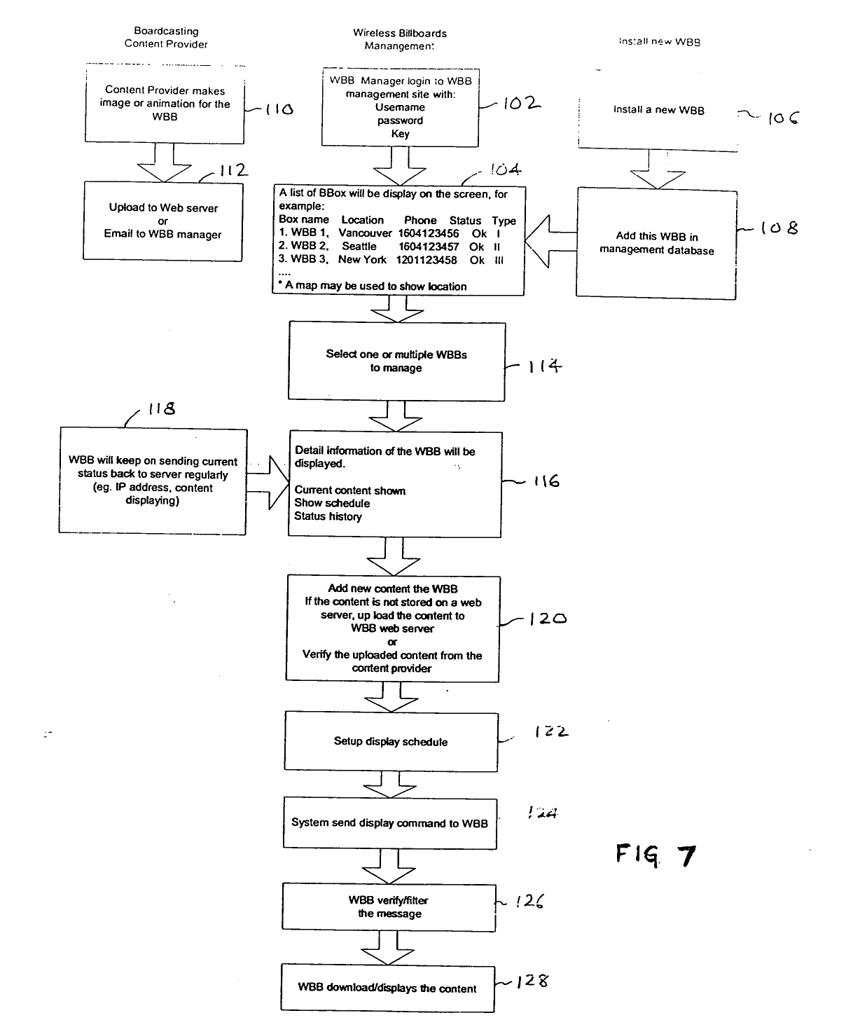

Referring to FIG. 7, the operation of the wireless billboard network commences with the wireless billboard (WBB) logging in at step 102 to the WBB management site using a user name, password and a key. At step 104 a map showing the WBB installations with box name, location and phone number is displayed. Any new installations of WBB are effected at step 106 and then at step 108 added to the WBB management database.

At step 114 the WBB's to be managed are selected. At step 116 detailed information of the WBB is displayed. At step 118 WBB repeatedly sends its current status back to the server regularly including information such as its IP address and the content to be displayed.

At step 120, new content is added to the WBB if the content is not stored on a web server. Alternatively, the content uploaded from the content provider is verified. At step 122 the schedule for the display is setup, then at step 124, a display command is sent to the WBB. At step 126 the WBB verifies and/or filters the message and at step 128 the WBB downloads or displays the content.

At step 110 the content provider makes image or animation for the WBB and, at step 112 uploads this to the web server 18. Alternatively, the image or animation is emailed to the WBB manager.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A wireless billboard system, comprising:
(a) a wireless billboard operative to receive and display text and graphics and to transmit messages wirelessly;
(b) a plurality of transmitter/receiver sites located so as to receive wireless signals transmitted from a transmission site and to transmit them to said wireless billboard and to receive wireless transmissions from each of said wireless billboards and to transmit them to a user's mobile phone; and
(c) a billboard management site couplable to each of said transmitter/receiver sites and operative to receive transmissions from said plurality of transmitter/receiver sites and to transmit wirelessly to said transmitter/receiver sites.

2. A system according to claim 1, wherein said wireless billboard has its own identity.

3. A wireless billboard system, comprising:
(a) a wireless billboard operative to display text and graphics transmitted to it wirelessly;
(b) a carrier network located so as to receive and transport wireless signals and to transmit them to and receive them from a wireless billboard and to transmit them to and receive them from a transmission site and operative to receive transmissions from and transmit to a user;
(d) a gateway operative to wirelessly transmit to and receive wireless transmissions from said carrier network;
(e) a content server coupled to said gateway and operative to transmit data to and receive data from said gateway; and
(f) a billboard management computer, coupled to said content server and operative to control operation of said wireless billboard system.

4. The system according to claim 3, wherein said user is a mobile phone.

5. A wireless billboard system, comprising:
(a) a plurality of wireless billboards, each operative to display text and graphics transmitted to them wirelessly;
(b) a carrier network located so as to receive and transport wireless signals transmitted to it from a transmission site and to receive and transport wireless signals from said wireless billboards and to transmit the signals received from said transmission site to said wireless billboards and operative to receive transmissions from and transmit to a user;
(g) a gateway operative to wirelessly transmit signals to and receive signals from said carrier network;
(h) a content server coupled to said gateway and operative to transmit data to and receive data from said gateway; and
(i) a billboard management computer, coupled to said content server and operative receive data from and to transmit data to said content server and to control operation of said wireless billboards.

6. A system according to claim 5, wherein each of said billboards has its own identity.

7. The system according to claim 5, wherein said user is a mobile phone.

8. A wireless billboard system, comprising:
(a) a plurality of wireless billboards operative to display text and graphics transmitted to them wirelessly
(b) a carrier network located so as to receive and transport signals sent wirelessly and to transmit wireless signals to said wireless billboards and to a transmission site and operative to receive wireless transmissions from and transmit wireless signals to a user;
(c) a gateway operative to wirelessly transmit data to and receive data from said carrier network;
(d) a web server coupled to one network of an Internet network and an intranet network and to said gateway and operative to transmit data to and receive data from said gateway and said one network; and
(e) a billboard management computer, coupled to said one network and operative to communicate with said web server to control operation of said wireless billboard system.

9. A system according to claim 8, wherein said web server also communicates with a member of the group consisting of a laptop computer and a commercial content provider.

10. A system according to claim 8, wherein each of said billboards has its own distinct identity.
